(19) United States
(12) Patent Application Publication
(10) Pub. No.: US 2020/0204858 A1
(43) Pub. Date: Jun. 25, 2020

(54) MEDIA CONTENT DELIVERY

(71) Applicant: Sky CP Limited, Isleworth Middlesex (GB)

(72) Inventors: ANDREW OLSON, Isleworth (GB); MATTHEW JON MARSH, Isleworth Middlesex (GB)

(21) Appl. No.: 16/612,521

(22) PCT Filed: May 10, 2018
(86) PCT No.: PCT/EP2018/062171

§ 371 Date: Nov. 11, 2019

(30) Foreign Application Priority Data
May 12, 2017 (GB) 1707655.5

(51) Int. Cl. H04N 21/433; H04N 21/436; H04N 21/4147; H04N 21/643; H04N 21/472

(52) U.S. Cl. CPC H04N 21/4331; H04N 21/43615; H04N 21/4334; H04N 21/64322; H04N 21/47202; H04N 21/4147

(57) ABSTRACT

A network recording cache prioritises delivery of content to a household based on a combination of viewing and recording requests. Content for viewing may be prioritised over content to be recorded. Cached content (e.g., for trick play) for content being viewed may be prioritised over recordings. In this way, the effect of limited bandwidth on the ability of the user to view and record requested content is reduced.

### FIELD OF THE INVENTION

The present invention relates to a system for media content delivery to one or more local media receiving devices.

### BACKGROUND OF THE INVENTION

In a conventional broadcast receiving and recording device, such as a PVR (personal video recorder), the device is able to receive a plurality of media content streams simultaneously. One or more of these streams may be viewed live and/or recorded for later viewing. The number of streams that can be received and decoded simultaneously may be determined by the number of tuners/decoders in the device. The bandwidth of the broadcast medium itself is sufficient to carry all of the available media content streams simultaneously.

An IPTV (Internet Protocol TV) receiver may receive one or more media content streams via an Internet connection. The number and/or bandwidth of the streams is limited by the available bandwidth of the Internet connection. Hence, compared with a broadcast PVR, an IPTV receiver may be able to display and/or record relatively few streams simultaneously.

US-A-2007/0104456 discloses a method of selectively recording on a user's equipment or a network recording device according to resource availability. The programmes recorded on the network recording device may be transferred to the user's equipment when there are sufficient resources, or may be played back as VOD (video on demand).

### STATEMENTS OF THE INVENTION

According to one aspect of the present invention, there is provided a network recording cache that prioritises delivery of media content to a household based on a combination of viewing and recording requests from a media (e.g. IPTV) client. Media content for viewing may be prioritised over media content to be recorded. Cached content (e.g. for trick play) for media content being viewed may be prioritised over recordings. In this way, the effect of limited bandwidth on the ability of the user to view and record requested content is reduced.

The network recording cache preferably caches content that may be shared between a plurality of different households, and is located outside the households in terms of network topology. Cached content that is no longer required by any household may be deleted. This may reduce the storage requirements of the network recording cache. Alternatively or additionally, a rights management policy that prevents permanent recording of cached content may be observed.

The word ‘household’ in the context of the present invention is not limited to domestic premises; the invention is also applicable to commercial or other premises.

According to another aspect of the invention, there is provided a method of delivering a plurality of media content streams to one or more clients via a bandwidth-restricted network connection, the method comprising: receiving at least one viewing request and at least one recording request from the one or more clients; and delivering, over the bandwidth-restricted network connection, at least one viewing stream in response to the at least one viewing request and at least one recording stream in response to the at least one recording request; wherein delivery of the at least one viewing stream is prioritised over delivery of the at least one recording stream.

### BRIEF DESCRIPTION OF THE DRAWINGS

There now follows, by way of example only, a detailed description of embodiments of the present invention, with reference to the figures identified below.

FIG. 1 is a diagram of a content delivery network (CDN) in a first example of use in an embodiment of the invention.

FIG. 2 is a diagram of the CDN in a second example of use.

FIG. 3 is a diagram of a part of the CDN illustrating the operation of a content storage policy.

### DETAILED DESCRIPTION OF THE EMBODIMENTS

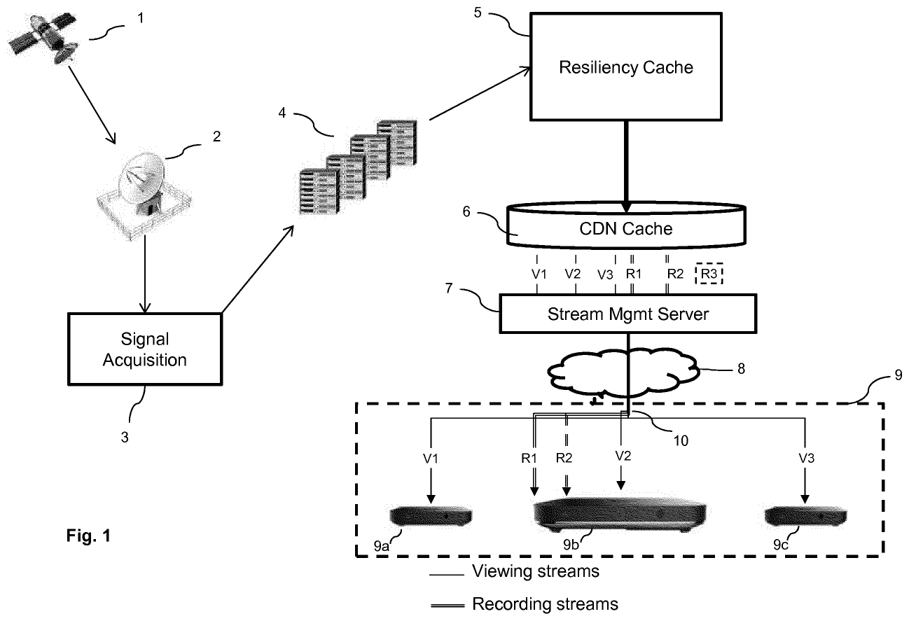

FIG. 1 shows a CDN in an embodiment of the invention, in which media content signals are broadcast via a satellite 1, received by a ground station 2 and acquired by a signal acquisition stage 3, which decodes the broadcast channels into a plurality of content streams, for example corresponding to broadcast TV and/or audio channels. The content streams are converted to IP (Internet Protocol) broadcast streams by an encoder or plurality of encoders 4. Thus far, the arrangement represents a conventional satellite to IP (Sat>IP) broadcast system, by way of example of a system to which embodiments of the invention may be applied. However, the present invention is not limited to Sat>IP systems or IP broadcast systems.

In this embodiment, the IP streams are received by a resiliency cache 5 that temporarily records (e.g. caches or buffers) some or all of the media content from the IP streams. For example, the resiliency cache 5 may record all programmes in all channels over a predetermined period, such as a given number of minutes or hours. Alternatively, or additionally, the resiliency cache 5 may receive collated recording requests from users relating to scheduled programmes to be recorded in future, and may record those scheduled programmes as the corresponding streams are received.

Media content recorded by the resiliency cache 5 may be provided to a CDN cache 6, which provides media content streams to individual households 9 over a network 8, such as the Internet.

Each household 9 may comprise one or more IPTV client devices 9a, 9b, 9c, which may be connected via a Local Area Network (LAN) to the network 8, for example via a household broadband connection 10. Hence, the available bandwidth of the household broadband connection 10 to the network 8 may be shared between the IPTV client devices 9a, 9b, 9c, together with any other IP client devices within the household 9.

One or more live streams and/or one or more recording streams may be requested by the IPTV client devices 9a, 9b, 9c to a stream management server 7 which manages requests for, and provision of streams from the CDN cache 6. In the example shown in FIG. 1, first and third IPTV client devices 9a, 9c are viewing-only clients, which request corresponding viewing streams V1 and V3. Second IPTV client device 9b is a viewing and recording client capable of requesting and simultaneously receiving streams for viewing and recording, for example on a local storage device. The first and third IPTV client devices 9a, 9c may play back, over the LAN, recordings stored by the second IPTV client device 9b.

The requests for specific viewing and recording streams are received by the stream management server 7, which provides access to the corresponding content from the CDN cache 6 as IP streams to the IPTV client devices 9a, 9b, 9c. The IP streams may be provided using an IP streaming protocol, such as HTML5 Smooth Streaming, DASH (Dynamic Adaptive Streaming over HTTP), HLS (HTTP Live Streaming), in which the stream is delivered as fragments rather than as a monolithic file, and in which random access is provided to different points within the stream. The IP streaming protocol may allow lower quality media streams (variant streams) depending on the available bandwidth.

Requests for future scheduled recordings are passed to the resiliency cache 5 for recording, as described above.

In the example shown in FIG. 1, the second IPTV client device requests one viewing stream V2 and three simultaneous recording streams R1, R2, R3. Hence, there is a demand from the household 9 for six simultaneous content streams altogether, which exceeds the bandwidth available to the household 9. To overcome this bandwidth limitation, the stream management server 7 prioritises the delivery of viewing streams V1, V2, V3 and recording streams R1, R2, R3 to the household 9. The stream management server 7 may determine the bandwidth available to the household 9 in advance, or may detect the available bandwidth from the behaviour of the client devices 9a, 9b, 9c in retrieving fragments of a stream and/or of the CDN cache 6 in delivering those fragments,

In the first instance, delivery of the viewing streams V1, V2, V3 may be prioritised over delivery of the recording streams R1, R2, R3, so as to enable the viewing streams V1, V2, V3 to be delivered to the IPTV client devices 9a, 9b, 9c on request and without substantial delay.

The stream management server 7 may prioritise delivery between the different recording streams R1, R2, R3 using different delivery techniques. For example, a first, high priority recording stream R1 may be delivered in real time (i.e. with the full bandwidth required for viewing), for example using pull down via a manifest. A second, medium priority recording stream R2 may be delivered in non-real time (i.e. with a bandwidth lower than that required for viewing), again using pull down via a manifest. A third, low priority recording stream R3 may be queued by the stream management server 7 until sufficient bandwidth becomes available at the household 9 for the low priority recording stream R3 to be delivered. The priority of the recording stream R3 may then be increased to medium priority (non-real time delivery) or high priority (real-time delivery).

Prioritisation between different recordings R1, R2, R3 may be applied according to one or more criteria such as time of recording request (e.g. earlier requests for recording are prioritised over later requests, or vice versa), programme type, explicit or inferred user or household preference or network determined priority.

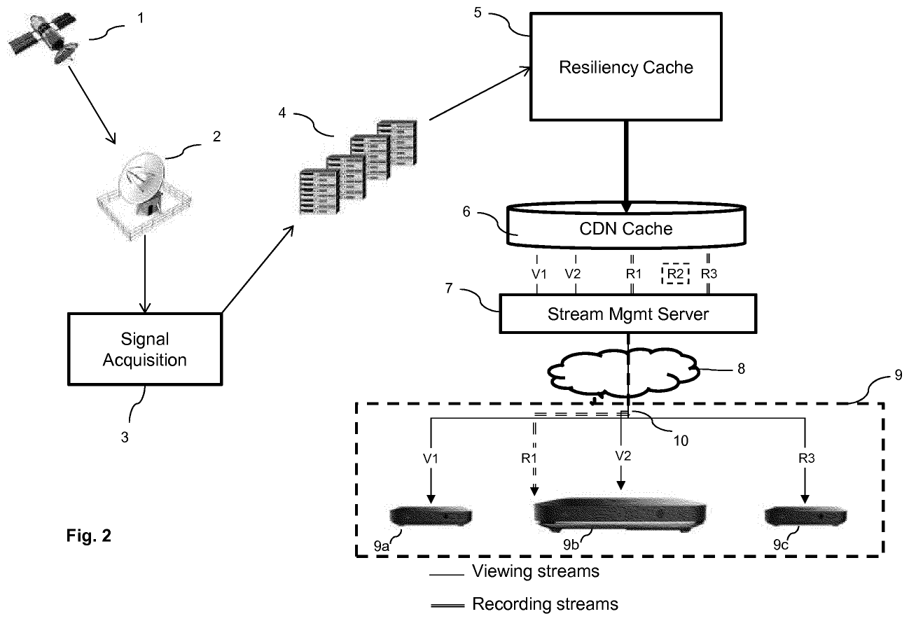

The IPTV client devices 9a, 9b, 9c may change viewing stream, for example by switching to viewing a stream that was previously requested as a recording. FIG. 2 illustrates a case where the third IPTV client device 9c switches from the third viewing stream to requesting viewing of the third recording stream R3. Previously, as shown in FIG. 1, the third recording stream R3 was queued and not delivered to the household 9. Hence, the stream management server 7 re-prioritises third recording stream R3 as a viewing stream, so that it is delivered in real time to the third IPTV client device 9c. The third viewing stream V3 is no longer required and is removed from the set of streams to be delivered by the stream management server 7 to the household 9 (although this stream may still be delivered as a viewing or recording stream to other households). The first recording stream R1 is reduced to medium priority (non-real time delivery), and the second recording stream R2 is reduced to low priority (queued).

To allow trick play modes, such as pausing and rewinding or fast forwarding content streams, one or more of the IPTV client devices 9a, 9b, 9c may cache the viewing streams V1, V2, V3 locally within the household 9, for example, on the second, recording enabled IPTV client device 9b. Where a viewing stream V1, V2, V3 has been previously received as a recording stream, the previously locally recorded content may be provided to a requesting IPTV client device 9a, 9b, 9c as rewind content. However, if a previously requested recording stream R1, R2, R3 is queued, then the content of that stream cannot be cached locally to allow rewind, when the previously requested recording stream is subsequently requested as a viewing stream, as in the scenario shown in FIG. 2.

To address this scenario, the stream management server 7 prioritises the delivery of previous content from the third recording stream R3 (which is now a viewing stream), over other recording streams such as the first and second recording streams R1 and R2. This previous content is then cached or buffered locally so that the user of the third IPTV client device 9c may rewind or skip back the viewing point to view this previous content. If the user requests a new viewing point for content which is not cached locally, then delivery of the previous content may be provided for content before this viewing point. In this way, trick play modes may be provided for content that has not been previously recorded locally.

Where there is insufficient bandwidth available to the household 9 to provide all of the requested viewing streams V1, V2, V3 in high quality, one or more of the viewing streams V1, V2, V3 may be provided at lower quality, for example using a variant stream.

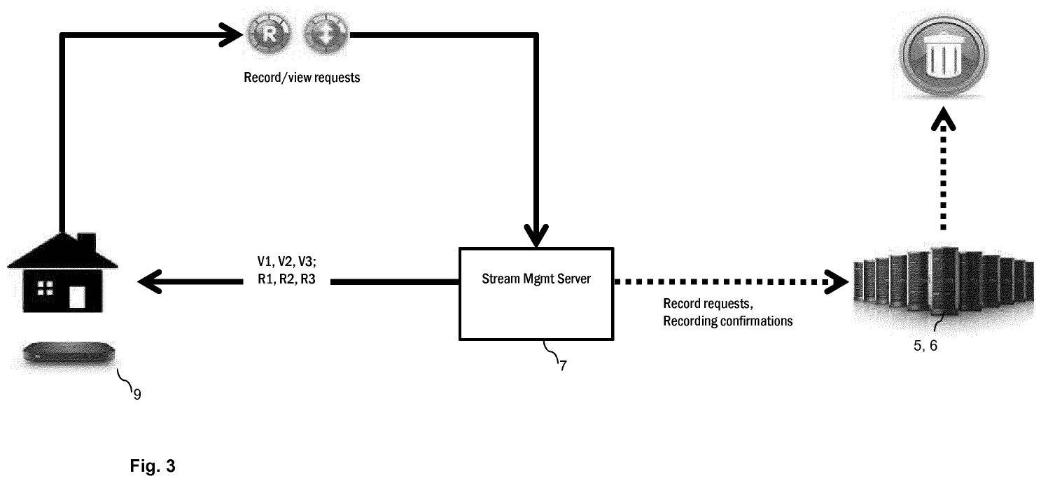

FIG. 3 illustrates a caching policy applied by the resiliency cache 5 and/or CDN cache 6. These caches 5, 6 temporarily store content for the purpose of delivery to the IPTV client devices 9a, 9b, 9c, in particular for content for which recording requests have been received from the IPTV client devices 9a, 9b, 9c but delivery of the requested content is delayed due to bandwidth constraints of the corresponding households 9.

The stream management server 7 receives viewing and recording requests from the IPTV client devices 9a, 9b, 9c of a plurality of households, and determines when the requested content has been delivered. If no recording requests are received for a specific content item, such as a programme, then that content item is not cached in the caches 5, 6. If one or more recording requests have been received for a specific content item, the content item is deleted from the cache after the content item has been delivered to all of the IPTV client devices that requested recording of that content item. The same approach may be applied to fragments of a content item: if a fragment has been delivered to all of the IPTV client devices, then that fragment may be deleted from the caches 5, 6, even though other fragments of the content item have not yet been delivered. In this way, the content items are temporarily cached but not permanently recorded in the caches 5, 6.

Where a content item has been only partially recorded within a household 9, for example because the viewer skipped forward within the content item, or part of the content item was only delivered at lower quality because of network congestion, the missing fragments of the content item may be pulled down to the household, as prioritised by the stream management server 7. This then allows the content to be deleted from the caches 5, 6.

### ALTERNATIVE EMBODIMENTS

Alternative embodiments may be envisaged on reading the present application, which nevertheless fall within the scope of the following claims.

1: A method of delivering a plurality of media content streams to one or more clients within a household via a bandwidth-restricted network connection to the household, the method comprising:
a) receiving, from the one or more clients, one or more viewing requests for media content to be viewed and one or more recording requests for media content to be recorded;
b) delivering, over the bandwidth-restricted network connection, one or more viewing streams containing the media content to be viewed and one or more recording streams containing the media content to be recorded;
wherein delivery of at least one of the viewing streams is prioritised over delivery of at least one of the recording streams; and
the media content for the at least one of the recording streams is cached before delivery over the bandwidth-restricted network connection.

2: The method of claim 1, wherein the delivery of the at least one viewing stream is prioritised over the delivery of the at least one recording stream by delivering one or more said recording stream as a non-real time stream.

3: The method of claim 1, wherein the delivery of the at least one viewing stream is prioritised over the delivery of the at least one recording stream by queuing delivery of the at least one recording stream.

4: The method of claim 1, further comprising prioritising between a plurality of said recording streams delivered over the bandwidth-restricted connection.

5: The method of claim 1, further comprising, in response to a change in the at least one viewing request from the one or more clients, delivering at least one viewing stream corresponding to the change, with priority over delivery of the at least one recording stream.

6: The method of claim 1, further comprising delivering via the network connection previous content from the at least one viewing stream with priority over delivery over the at least one recording stream.

7: The method of claim 6, wherein the previous content is delivered via the network connection if not available within the household.

8: The method of claim 1, further comprising deleting the cached media content after delivery thereof.

9: The method of claim 8, wherein the cached media content is recorded in a cache that stores media content requested by clients from a plurality of households, and the cached media content is deleted after delivery thereof to each of said clients.

10: The method of claim 9, wherein the cached media content is recorded as a plurality of fragments, and each fragment of the cached content is deleted from the cache after delivery of that fragment to each of said clients.

11: A method of delivering a requested media content item to a plurality of clients, the method comprising:
a) receiving delivery requests relating to the content item from the plurality of clients;
b) caching the content item in a cache;
c) delivering the cached content item to the plurality of clients, in respective media streams comprising a plurality of fragments; and
d) deleting a fragment of the cached content item from the cache after delivery of that fragment to each of the plurality of clients.

12: An apparatus arranged to perform the method of claim 1.

13: A non-transitory computer program product comprising program code means arranged to perform the method of claim 1.

14: A system for delivering a plurality of media content streams to one or more clients via a bandwidth-restricted network connection, the system comprising:
a) a cache for storing media content;
b) a stream manager for making the media content available as media content streams in response to viewing and recording requests; and
c) one or more media clients connected to the stream manager via a bandwidth-limited network connection;
wherein the stream manager is arranged to receive at least one viewing request and at least one recording request from the one or more clients, and to make available to the one or more clients over the bandwidth-restricted network connection at least one viewing stream corresponding to the at least one viewing request and at least one recording stream corresponding to the at least one recording request, such that delivery of the at least one viewing stream is prioritised over delivery of the at least one recording stream.

15: A system for delivering a requested media content item to a plurality of clients, the system comprising:
a) a stream manager for receiving delivery requests relating to the content item from the plurality of clients; and
b) a cache for caching the content item and delivering the cached content item to the plurality of clients, in respective media streams comprising a plurality of fragments; and deleting a fragment of the cached content item from the cache after delivery of that fragment to each of the plurality of clients.
